(19) United States
(12) Patent Application Publication
(10) Pub. No.: US 2026/0320293 A1
(43) Pub. Date: Oct. 15, 2026

(54) ELECTRONIC DEVICE FOR EXTRACTING KEYWORDS USING DICTIONARY INFORMATION AND OPERATION METHOD THEREOF

(71) Applicant: SAMSUNG ELECTRONICS CO., LTD., Suwon-si (KR)

(72) Inventors: Hyein HYUN, Suwon-si (KR); Yongsung KIM, Suwon-si (KR); Kyungsu KIM, Suwon-si (KR)

(73) Assignee: SAMSUNG ELECTRONICS CO., LTD., Suwon-si (KR)

(21) Appl. No.: 19/461,104

(22) Filed: Jan. 27, 2026

Related U.S. Application Data
(63) Continuation of application No. PCT/KR2026/000382, filed on Jan. 7, 2026.

(30) Foreign Application Priority Data
Jan. 8, 2025 (KR) 10-2025-0002751

(51) Int. Cl. G06F 40/242; G06F 40/279

(52) U.S. Cl. CPC G06F 40/242; G06F 40/279

(57) ABSTRACT

An electronic device to obtain at least one keyword from an input document using dictionary information. The dictionary information corresponds to a category of the input document. The dictionary information includes 1) a plurality of keywords associated with the category and 2) a keyword weight associated with each keyword of the plurality of keywords. The electronic device to obtain at least one adjacent word for the at least one keyword from the input document using a window slide. The window slide has a length set based on document density information of the input document. The electronic device to perform a designated task for the input document using the at least one keyword and the at least one adjacent word.

### CROSS-REFERENCE TO RELATED APPLICATIONS

This application is a continuation of International Application PCT/KR 2026/000382, filed on Jan. 7, 2026, which is based on and claims priority to Korean Patent Application No. 10-2025-0002751, filed on Jan. 8, 2025, in the Ministry of Intellectual Property, the disclosure of which is incorporated by reference herein in its entireties.

### BACKGROUND

### 1. Field

The disclosure relates to an electronic device and an operation method for extracting keywords using a pre-generated dictionary.

### 2. Description of Related Art

A document processing system generally performs a designated task using all of the text data included in a document as input data. This method may reduce the accuracy of an analysis for the document as the size of the input data increases by including unnecessary data. There is an increasing demand for technology to efficiently process documents using only specific words extracted from an input document as input data.

The above-described information may be provided as related art for the purpose of helping understanding of the disclosure. No claim or determination is made as to whether any of the foregoing is applicable as background art in relation to the disclosure.

### SUMMARY

According to an embodiment of the disclosure, an electronic device including at least one processor including processing circuitry and memory configured to store instructions. The instructions, when executed individually or collectively by the at least one processor, cause the electronic device to: obtain at least one keyword from an input document using dictionary information. The dictionary information corresponds to a category of the input document, and the dictionary information includes 1) a plurality of keywords associated with the category and 2) a keyword weight associated with each keyword of the plurality of keywords. The electronic device to: obtain at least one adjacent word for the at least one keyword from the input document using a window slide. The window slide has a length set based on document density information of the input document. The electronic device to: perform a designated task for the input document using the at least one keyword and the at least one adjacent word.

In an embodiment, the document density information includes a value obtained by dividing a total number of characters included in the input document by a total area of the characters included in the input document.

In an embodiment, the instructions, when executed individually or collectively by the at least one processor, cause the electronic device to: obtain the document density information using character clustering configured to detect each character included in the input document using a detection box.

In an embodiment, the instructions, when executed individually or collectively by the at least one processor, cause the electronic device to: generate a dictionary including the dictionary information based on 1) visual information for each word included in a plurality of sample documents and 2) frequency information for each word included in the plurality of sample documents.

In an embodiment, generating the dictionary includes: obtaining the plurality of sample documents; calculating a visual weight for each word included in the plurality of sample documents; performing layout clustering on the plurality of sample documents to classify a category of each sample document in the plurality of sample documents; calculating a frequency weight per category for each word included in the plurality of sample documents; and generating the dictionary based on the visual weight and the frequency weight.

In an embodiment, the dictionary includes dictionary information corresponding to each category of a plurality of categories, the dictionary information corresponding to each category of the plurality of categories includes 1) a plurality of keywords associated with a corresponding category and 2) a keyword weight associated with each of the plurality of keywords associated with the corresponding category, and the keyword weight is set as a product of a visual weight and the frequency weight for a corresponding keyword.

In an embodiment, the visual weight is set based on a value obtained by dividing an area occupied by a word in a corresponding sample document by a number of characters included in the word. The frequency weight per category is set based on a value obtained by dividing a ratio of where a word is detected in at least one sample document of a corresponding category by a ratio of where the word is detected in sample documents of categories other than the corresponding category.

In an embodiment, to obtain the at least one keyword includes extracting K keywords having highest keyword weight values among a plurality of keywords included in the input document matching the plurality of keywords included in the dictionary information. A value of K is set based on at least one of a size of a model used to perform the designated task, a size of input data of the model, or a memory environment of the electronic device.

In an embodiment, the category of the document includes at least one of a resume, a name card, a credit card, an identification card, an e-mail, or a form.

In an embodiment, the designated task is performed based on a task execution module. The task execution module includes at least one of a document classification model, a document key-value extraction model, or a document-based generative data generation model.

In an embodiment, the task execution module includes an attention mechanism-based model, the attention mechanism-based model is configured to receive, as input data, information about weight together with the at least one keyword and the at least one adjacent word, and to perform the designated task for the input document, and the information about weight includes information about a keyword weight of the at least one keyword included in the dictionary information or information about a weight obtained by multiplying the keyword weight of the at least one keyword included in the dictionary information by a visual weight of the at least one keyword.

According to an embodiment of the disclosure, a method of an electronic device is provided. The method including obtaining at least one keyword from an input document using dictionary information. The dictionary information corresponds to a category of the input document, and the dictionary information includes 1) a plurality of keywords associated with the category and 2) a keyword weight associated with each keyword of the plurality of keywords. The method includes obtaining at least one adjacent word for the at least one keyword from the input document using a window slide. The window slide has a length set based on document density information of the input document. The method includes performing a designated task for the input document using the at least one keyword and the at least one adjacent word.

In an embodiment, the document density information includes a value obtained by dividing a total number of characters included in the input document by a total area of the characters included in the input document.

In an embodiment, the method includes obtaining the document density information using character clustering configured to detect each character included in the input document using a detection box.

In an embodiment, the method includes generating a dictionary including the dictionary information based on 1) visual information for each word included in a plurality of sample documents and 2) frequency information for each word included in a plurality of sample documents.

In an embodiment, generating the dictionary includes: obtaining the plurality of sample documents; calculating a visual weight for each word included in the plurality of sample documents; performing layout clustering on the plurality of sample documents to classify a category of each sample document in a plurality of sample documents; calculating a frequency weight per category for each word included in the plurality of sample documents; and generating the dictionary based on the visual weight and the frequency weight.

In an embodiment, the dictionary includes dictionary information corresponding to each category of a plurality of categories, the dictionary information corresponding to each category of the plurality of categories includes 1) a plurality of keywords associated with a corresponding category and 2) a keyword weight associated with each of the plurality of keywords associated with the corresponding category, and the keyword weight is set as a product of a visual weight and the frequency weight for a corresponding keyword.

In an embodiment, the visual weight is set based on a value obtained by dividing an area occupied by a word in a corresponding sample document by a number of characters included in the word. The frequency weight per category is set based on a value obtained by dividing a ratio of where a word is detected in at least one sample document of a corresponding category by a ratio of where the word is detected in sample documents of categories other than the corresponding category.

In an embodiment, obtaining the at least one keyword includes extracting K keywords having highest keyword weight values among a plurality of keywords included in the input document matching the plurality of keywords included in the dictionary information. A value of K is set based on at least one of a size of a model used to perform the designated task, a size of input data of the model, or a memory environment of the electronic device.

In an embodiment, the designated task is performed based on a task execution module. The task execution module incudes an attention mechanism-based model, the attention mechanism-based model is configured to receive, as input data, information about weight together with the at least one keyword and the at least one adjacent word, and to perform the designated task for the input document, and the information about weight includes information about a keyword weight of the at least one keyword included in the dictionary information or information about a weight obtained by multiplying the keyword weight of the at least one keyword included in the dictionary information by a visual weight of the at least one keyword.

### BRIEF DESCRIPTION OF THE DRAWINGS

The same or similar reference denotations may be used to refer to the same or similar elements throughout the specification and the drawings.

FIG. 1 is a block diagram illustrating an electronic device in a network environment according to various embodiments of the disclosure.

FIG. 2 is a view illustrating a configuration of an electronic device performing a document-based task according to an embodiment of the disclosure.

FIG. 3 is a flowchart illustrating an operation of an electronic device performing a document-based task according to an embodiment of the disclosure.

FIG. 4 is a flowchart illustrating a method for an electronic device to generate a dictionary for keywords according to an embodiment of the disclosure.

FIG. 5 is a view illustrating an operation of an electronic device obtaining a visual weight for generating a dictionary according to an embodiment of the disclosure.

FIG. 6 is a flowchart illustrating a method for an electronic device to perform a designated task using a generated dictionary according to an embodiment of the disclosure.

FIGS. 7A to 7C are views illustrating an operation of an electronic device extracting keywords and adjacent words from an input document using a generated dictionary according to an embodiment of the disclosure.

FIG. 8 is a view illustrating an operation of an electronic device obtaining document density and window slide length using character clustering according to an embodiment of the disclosure.

FIG. 9 is a view illustrating an operation of an electronic device obtaining adjacent words for keywords using window slide length according to an embodiment of the disclosure.

FIG. 10 is a view illustrating an example of window slide length set differently according to document density according to an embodiment of the disclosure.

FIG. 11A is a view illustrating an operation of an electronic device performing a document classification task using a first method according to an embodiment of the disclosure.

FIG. 11B is a view illustrating an operation of an electronic device performing a document classification task using a second method according to an embodiment of the disclosure.

FIG. 12A is a view illustrating an operation of an electronic device performing a document key-value extraction task using a first method according to an embodiment of the disclosure.

FIG. 12B is a view illustrating an operation of an electronic device performing a document key-value extraction task using a second method according to an embodiment of the disclosure.

FIGS. 13A and 13B are views illustrating an operation of an electronic device performing a designated task using weights together with keywords and adjacent words according to an embodiment of the disclosure.

FIG. 14 is a view illustrating an operation of an electronic device performing a designated task through an attention-based model using weights according to an embodiment of the disclosure.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

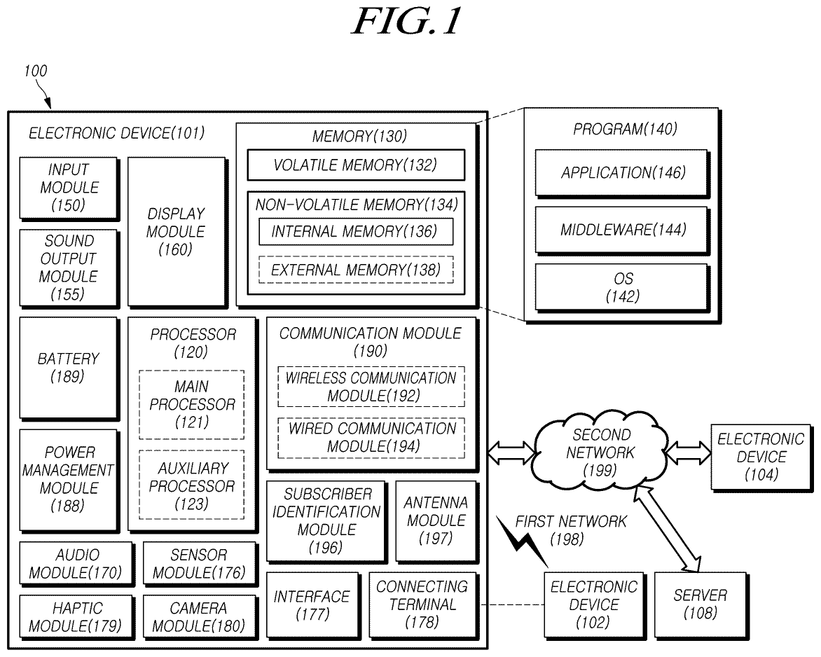

FIG. 1 is a block diagram illustrating an electronic device in a network environment according to various embodiments of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The communication module 192 may identify or authenticate the electronic device 101 in a communication network, such as the first network 198 or the second network 199, using subscriber information (e.g., international mobile subscriber identity (IMSI)) stored in the subscriber identification module 196.

The communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The communication module 192 may support a high-frequency band (e.g., the mmWave band) to achieve, e.g., a high data transmission rate. The communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The communication module 192 may support various requirements specified in the electronic device 101, an external electronic device (e.g., the electronic device 104), or a network system (e.g., the second network 199). According to an embodiment, the communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The number of processors 120 may be one or more. For example, the processor 120 may have a structure of a multi-core processor such as dual core, quad core, or hexa core.

The processor 120 may control the operations of the electronic device 101 by executing the instructions stored in the memory 130. For example, the processor 120 may correspond to a plurality of processors that divide a plurality of operations between processors and collectively perform the operations.

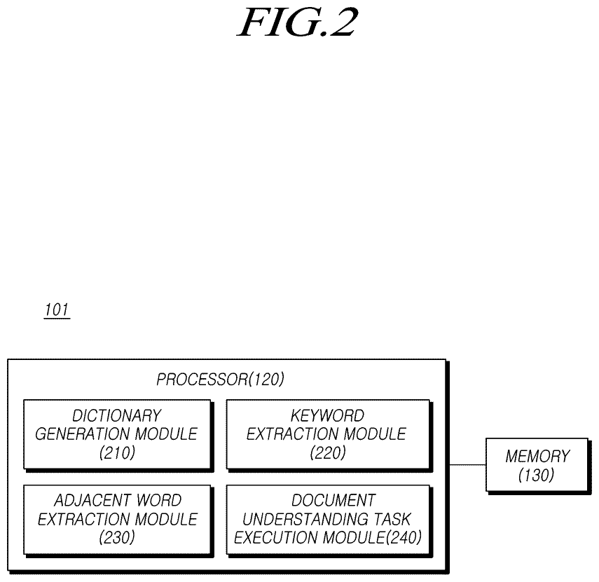

FIG. 2 is a view illustrating a configuration of an electronic device performing a document-based task according to an embodiment of the disclosure.

Referring to FIG. 2, an electronic device 101 may include at least one processor 120 and a memory 130.

According to an embodiment, the electronic device 101 may include at least one module for performing a document-based task. For example, the electronic device 101 may include a dictionary generation module 210, a keyword extraction module 220, an adjacent word extraction module 230, and/or a document understanding task execution module 240. In the disclosure, the document understanding task execution module 240 may be referred to as a task execution module.

According to an embodiment, the memory 130 may store instructions, and the instructions stored in the memory 130 may, when executed individually and/or collectively by the at least one processor 120, cause the electronic device 101 to perform at least one function of each module 210, 220, 230, and 240.

According to an embodiment, the dictionary generation module 210 may be a module for generating a dictionary used to extract at least one keyword from an input document. In the disclosure, the dictionary may be referred to as a keyword dictionary.

According to an embodiment, a keyword may be a word (e.g., a search term) used to obtain specific information (e.g., meaningful information or key information,) from an input document. Obtaining specific information from the input document may include, e.g., searching, identifying, and/or extracting specific information from the input document. For example, in case that an input document is a resume, “name” may be used as a keyword to obtain an actual name (e.g., James) of an applicant written in the resume as meaningful information through the document understanding task execution module 240 (e.g., the document understanding task execution module 240 including a key-value extraction model). In case of using keywords to obtain specific information from an input document in this way, the size of input data of a model used may be decreased compared to using all words included in the input document.

According to an embodiment, a dictionary may be used to extract at least one keyword from an input document. The dictionary may include dictionary information, and the dictionary information may include at least one keyword and/or a keyword weight associated with each keyword. In some embodiments, the dictionary may include one or more sets of dictionary information. The keyword weight may be associated with the importance of a corresponding keyword. For example, as the keyword weight increases, the corresponding keyword may be understood as a word having higher importance in the corresponding document. High importance may include, for example, that the corresponding keyword may be used more importantly to obtain desired specific information from an input document.

According to an embodiment, the dictionary generation module 210 may generate dictionary information for each category of documents of a plurality of categories using a plurality of sample documents. In some embodiments, each set of dictionary information may correspond to a specific category. The category of documents may include, for example, a resume, a name card, a credit card, an identification card, an e-mail, and/or a form, but the disclosure is not limited thereto. In the disclosure, a sample document may be referred to as a sample input document.

According to an embodiment, the dictionary generation module 210 may generate a dictionary using visual information of words. For example, the dictionary generation module 210 may generate a dictionary using visual information of a plurality of words (e.g., all words of a plurality of documents) included in a plurality of sample documents. The visual information may include, e.g., information about the area (or region) occupied by a word in a document, the proportion of the word, the thickness of the word, the size of the word, and/or the color of the word.

According to an embodiment, the dictionary generation module 210 may calculate a visual weight of a word using visual information. The visual weight may be used to calculate the keyword weight and may be set, for example, as a value obtained by dividing the area occupied by a word in a document (e.g., the corresponding sample document) by the number of characters included in the word. Such visual weight may be used, for example, to give high weight to visually highlighted or emphasized portions such as titles in documents. For example, the higher the visual weight of a word, the more likely the word needs to be visually emphasized in the corresponding document. In other words, the higher the visual weight of a word, the more likely the word has high importance in the corresponding document.

According to an embodiment, the dictionary generation module 210 may generate a dictionary using frequency information of words. For example, the dictionary generation module 210 may generate a dictionary using frequency information of a plurality of words (e.g., all words of a plurality of documents) included in a plurality of sample documents. The frequency information may include, for example, information about the frequency or ratio where the corresponding word is detected in at least one document (e.g., the corresponding sample document). The frequency information may be used together with visual information to generate a dictionary.

According to an embodiment, the dictionary generation module 210 may classify categories of a plurality of sample documents through layout clustering. Layout clustering may be grouping documents into groups or clusters having similar patterns by analyzing the arrangement, size, position, and/or attributes of elements (e.g., text, images, tables) in documents. Through such layout clustering, various visual structures (e.g., titles, body text, tables) of documents may be understood, and categories of documents may be identified.

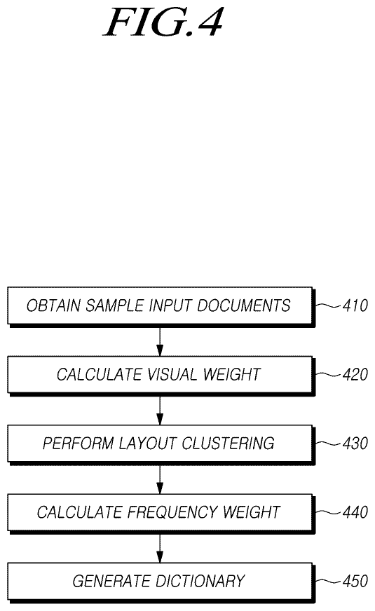

According to an embodiment, the dictionary generation module 210 may calculate a frequency weight using frequency information. For example, the dictionary generation module 210 may calculate a frequency weight per category for each of a plurality of words included in a plurality of sample documents using frequency information. The categories may be categories classified through operation 430 (see FIG. 4). The frequency weight per category may be calculated by the following Equation 1.

α=first ratio/second ratio Equation 1
where,
α is the frequency weight of word A for category A;
the first ratio is the ratio where word A is detected in document(s) of category A; and
the second ratio is the ratio where word A is detected in document(s) of category(ies) other than category A.

For example, in case that word A is TEL and category A is a name card,

The first ratio may be the number of name cards where TEL is detected divided by the number of name cards where TEL is not detected.

The second ratio may be the number of documents (except for name cards) where TEL is detected divided by the number of documents (except for name cards) where TEL is not detected.

Meanwhile, as the frequency weight of a word for a specific category (e.g., a first category) increases, it corresponds to the word being detected at a higher proportion in documents of the specific category rather than being detected in all documents. Therefore, the possibility that the word is a word with high importance in documents of the specific category may increase. In contrast, as the frequency weight of a word for a specific category (e.g., a first category) decreases, the ratio where the word is detected in all documents rather than documents of the specific category may increase. Therefore, the possibility that the word is not a word with high importance in documents of the specific category may increase. Such frequency weight per category may be used to identify whether the corresponding word has high importance in a specific category.

According to an embodiment, the dictionary generation module 210 may calculate a keyword weight using a visual weight and a frequency weight (e.g., frequency weight per category). For example, the keyword weight may be set as a value obtained by multiplying the visual weight and the frequency weight. As described above, as the keyword weight increases, the corresponding keyword may be understood as a word having higher importance in the corresponding document (or category of the corresponding document). As described above, high importance of a keyword may include, for example, that the corresponding keyword may be used as more important information than other words or keywords to obtain specific information from an input document.

According to an embodiment, the dictionary generation module 210 may select at least one keyword for the corresponding document using keyword weights. For example, the dictionary generation module 210 may select words having the highest K (top K) keyword weight values among keyword weights of each word included in a document of a specific category as keywords for documents of the corresponding category. Through generation of such a dictionary (or dictionary information), keywords for the corresponding document (or category of the corresponding document) may be predefined which enables fast keyword extraction from an input document.

According to an embodiment, the K value may be set based on the size of a model used to obtain specific information from an input document (e.g., total number of parameters of the model, number of layers of the model), the size of input data input to the corresponding model (e.g., input token maximum length), and/or memory environment (e.g., peak memory value). Meanwhile, according to the embodiment, keyword selection using the K value may not be performed by the dictionary generation module 210 but may be performed by the keyword extraction module 220. In this case, the keyword extraction module 220 may set the K value, extract a plurality of words matching a plurality of keywords included in dictionary information using dictionary information corresponding to the category of the input document generated by the dictionary generation module 210, and select K words having the highest keyword weight values among the extracted plurality of words as keywords for the input document.

According to an embodiment, the keyword extraction module 220 may be a module for extracting at least one keyword from an input document using a pre-generated dictionary (or dictionary information). For example, the keyword extraction module 220 may obtain dictionary information corresponding to the category of an input document and extract at least one keyword based on the dictionary information. The dictionary information may include a plurality of keywords associated with the category and a keyword weight associated with each of the plurality of keywords. The operation of extracting at least one keyword may include, for example, analyzing an input document to extract at least one word matching at least one keyword included in the dictionary information as a keyword for the input document. According to an embodiment, the keyword extraction module 220 may perform layout clustering on an input document to identify the category of the input document.

According to an embodiment, the adjacent word extraction module 230 may be a module for extracting at least one adjacent word for the extracted at least one keyword. An adjacent word is a word adjacent to an extracted keyword and may be a word positioned before and/or after the extracted keyword. For example, in case that a keyword extracted from a document having the category of a resume is “Name”, adjacent words may be “a” positioned before “Name” and “of applicant” positioned after “Name”. Through such adjacent words, the contextual meaning of extracted keywords may become clearer. In the disclosure, an adjacent word may be referred to as a keyword adjacent word.

According to an embodiment, the adjacent word extraction module 230 may extract an adjacent word corresponding to an extracted keyword using a window slide having a length (or size) set based on document density information for an input document. The length of the window slide may be set, for example, in units of the number of words. For example, in case that the length of the window slide is 5, five words positioned before and/or after an extracted keyword may be included in the window slide. For example, five words positioned before and/or after an extracted keyword may be included in the window slide. All or some of the words included in the window slide may be set as adjacent words.

According to an embodiment, document density information may include information about document density, for example, information about how densely text (or characters) is disposed in the corresponding document. As the value of such document density information increases, it may be understood that characters are disposed more densely. Document density information (or document density) may be calculated using the following Equation 2.

Document density=total number of characters included in the input document/total area of characters included in the input document Equation 2

As the value of document density information increases, there may be more sentence-type text in the corresponding document. For example, relatively more context before and after a specific word (or keyword) may be needed to understand the specific word. Therefore, the length of the window slide may be set to a relatively large value (e.g., 5). As the value of document density information decreases, there may be more word-type text in the corresponding document. For example, relatively less context before and after a specific word (or keyword) may be needed to understand the specific word. Therefore, the length of the window slide may be set to a relatively small value (e.g., 2). By adaptively setting different window slide lengths according to document density information in this way, adjacent words for keywords of the corresponding document may be accurately obtained according to the characteristics of the document.

According to an embodiment, the adjacent word extraction module 230 may perform character clustering on an input document to generate document density information for the input document. Character clustering may be, for example, a clustering method configured to detect each character included in an input document using a detection box. Through such character clustering, the total number of characters, the size, thickness, and/or attributes of individual characters in an input document may be identified. The adjacent word extraction module 230 may generate document density information for the corresponding input document by dividing the total number of characters obtained using the result of character clustering for the input document by the total area of all characters. The total area of characters may be set as the area of a region (e.g., minimum rectangular region) including all detection boxes allocated to all characters.

According to an embodiment, the document understanding task execution module 240 may include at least one model for performing at least one designated task associated with a document based on understanding of the content of the document. The at least one model may include at least one of a document classification model, a document key-value extraction model, or a document-based generative data generation model, but the disclosure is not limited thereto. The document understanding task execution module 240 may perform a designated task based on at least one keyword and at least one adjacent word. The designated task may include, for example, document classification, document category classification, document summarization, document key-value extraction, and/or document-based generative data generation (e.g., generative language data, generative image data), but the disclosure is not limited thereto. The document understanding task execution module 240 may perform a designated task by further using information about weights together with at least one keyword and at least one adjacent word.

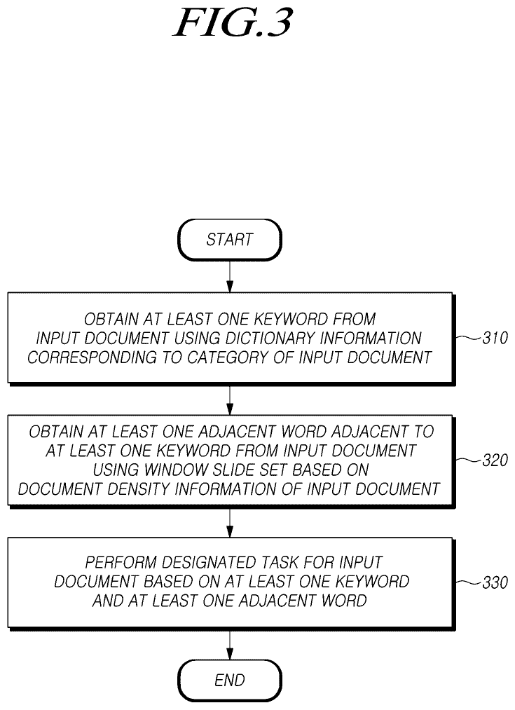

FIG. 3 is a flowchart illustrating an operation of an electronic device performing a document-based task according to an embodiment of the disclosure.

Referring to FIG. 3, in operation 310, an electronic device (e.g., the electronic device 101 of FIG. 1 or FIG. 2) may obtain (e.g., extract) at least one keyword from an input document using dictionary information corresponding to the category of the input document. Operation 310 may be performed, for example, by the keyword extraction module 220 of FIG. 2. Generation of the dictionary including dictionary information and/or dictionary information for a plurality of categories may be performed, for example, by the dictionary generation module 210 of FIG. 2. Operation 310 of FIG. 3 may include all or some of the operations of the dictionary generation module 210 and the keyword extraction module 220 described above in FIG. 2.

According to an embodiment, the electronic device may perform layout clustering on an input document to identify the category of the input document. According to an embodiment, the dictionary information may include a plurality of keywords associated with the corresponding category and/or a keyword weight associated with each of the plurality of keywords.

In operation 320, the electronic device may obtain (e.g., extract) at least one adjacent word adjacent to at least one keyword from the input document using a window slide having a length set based on document density information of the input document. Operation 320 may be performed, for example, by the adjacent word extraction module 230 of FIG. 2. Operation 320 of FIG. 3 may include all or some of the operations of the adjacent word extraction module 230 described above in FIG. 2.

According to an embodiment, the document density information may be set as a value obtained by dividing the total number of characters included in the input document by the total area of the characters included in the input document. According to an embodiment, the document density information may be obtained through character clustering configured to detect each character included in the input document using a detection box.

In operation 330, the electronic device may perform a designated task for the input document using at least one keyword and at least one adjacent word. The designated task may include, for example, document classification, document category classification, document summarization, document key-value extraction, and/or document-based generative data generation (e.g., generative language data, generative image data), but the disclosure is not limited thereto. Operation 330 may be performed, for example, by the document understanding task execution module 240 of FIG. 2. Operation 330 of FIG. 3 may include all or some of the operations of the document understanding task execution module 240 described above in FIG. 2.

According to an embodiment, the electronic device may generate a dictionary including dictionary information based on 1) visual information for each word included in a plurality of sample documents and 2) frequency information for each word. According to an embodiment, the operation of generating the dictionary may include obtaining a plurality of sample documents, calculating a visual weight for each word included in the plurality of sample documents, performing layout clustering on the plurality of sample documents to classify the category of each sample document, calculating a frequency weight per category for each word included in the plurality of sample documents, and generating the dictionary based on the visual weight and the frequency weight.

According to an embodiment, the dictionary may include dictionary information per category, each dictionary information may include a plurality of keywords associated with the corresponding category and a keyword weight associated with each of the plurality of keywords, and the keyword weight may be set as a product of the visual weight and the frequency weight for the corresponding keyword.

According to an embodiment, the visual weight may be set based on a value obtained by dividing the area occupied by a word in the corresponding sample document by the number of characters included in the word. The frequency weight per category may be set based on a value obtained by dividing the ratio where a word is detected in at least one sample document of the corresponding category by the ratio where the word is detected in sample documents of categories other than the corresponding category.

According to an embodiment, the operation of obtaining at least one keyword may include extracting K keywords having the highest keyword weight values among a plurality of keywords included in the input document matching the plurality of keywords included in the dictionary information. The value of K may be set based on the size of a model used to perform the designated task, the size of input data of the model, or the memory environment of the electronic device.

According to an embodiment, the category of the document may include at least one of a resume, a name card, a credit card, an identification card, an e-mail, or a form.

According to an embodiment, the designated task may be performed based on a task execution module. The task execution module may include at least one of a document classification model, a document key-value extraction model, or a document-based generative data generation model.

According to an embodiment, the task execution module may include an attention mechanism-based model. The attention mechanism-based model may be configured to receive, as input data, information about weight together with at least one keyword and at least one adjacent word, and to perform the designated task for the input document. The information about weight may include information about the keyword weight of at least one keyword included in the dictionary information or information about a weight obtained by multiplying the keyword weight of at least one keyword included in the dictionary information by the visual weight of at least one keyword.

According to an embodiment of the disclosure, an electronic device may increase the speed of keyword detection by extracting keywords (e.g., search terms) used to obtain specific information (e.g., meaningful information) from an input document using a pre-generated dictionary (or dictionary information per category).

According to an embodiment of the disclosure, an electronic device may increase the accuracy of adjacent word extraction by extracting adjacent words adjacent to keywords using a window slide having a length set based on density information of an input document.

According to an embodiment of the disclosure, an electronic device may make the contextual meaning of keywords clearer by performing a designated task using adjacent words together with keywords, thereby increasing the accuracy of task execution result data.

FIG. 4 is a flowchart illustrating a method for an electronic device to generate a dictionary for keywords according to an embodiment of the disclosure.

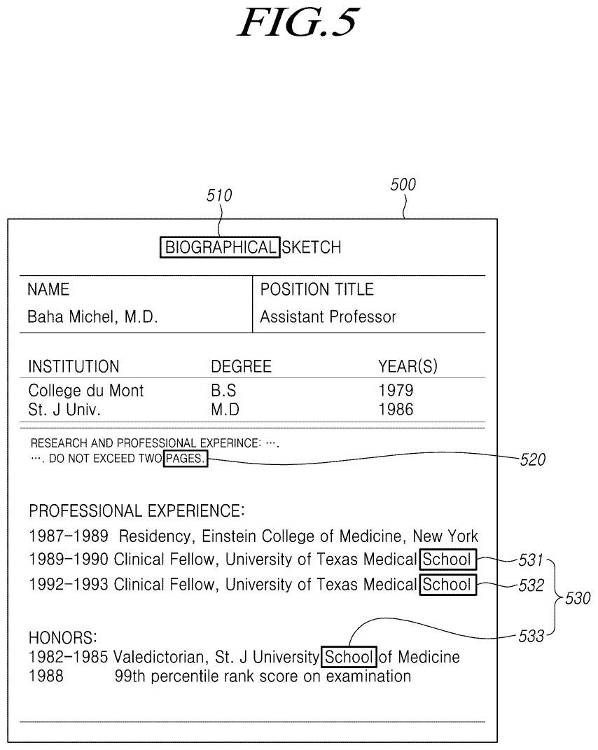

FIG. 5 is a view illustrating an operation of an electronic device obtaining a visual weight for generating a dictionary according to an embodiment of the disclosure.

According to an embodiment, the method of generating a dictionary may be performed by a dictionary generation module (e.g., the dictionary generation module 210 of FIG. 2). Operations 410 to 450 of FIG. 4 may include all or some of the operations of the dictionary generation module 210 described above in FIG. 2.

Referring to FIG. 4, in operation 410, an electronic device (e.g., the electronic device 101 of FIG. 1 or FIG. 2) may obtain sample input documents. According to an embodiment, the sample input documents may include a designated number (e.g., N) of documents having a fixed layout. In the disclosure, a sample input document may be referred to as a sample document.

In operation 420, the electronic device may calculate a visual weight. According to an embodiment, the electronic device may calculate a visual weight for each word included in the sample input documents.

According to an embodiment, the electronic device may calculate a visual weight for the corresponding word using visual information about a word (e.g., proportion of the word). For example, as illustrated in FIG. 5, the electronic device may detect each word included in a sample document 500 using a detection box, calculate the proportion of a word by dividing the area occupied by the word in the document 500 (e.g., the area of the detection box including the word) by the number of characters included in the word, and calculate the visual weight of the word using the proportion of the word.

According to an embodiment, the visual weight for a word may be a value obtained by multiplying the proportion of the word by the number of words included in the document. For example, as illustrated in FIG. 5, the proportion of a first word (e.g., BIOGRAPHICAL) of the sample document 500 may be a value (e.g., 1.2) obtained by dividing the area (e.g., 14.4) of a first detection box 510 including the first word by the number of characters (e.g., 12) of the first word Since only one first detection box 510 is detected, the visual weight (e.g., 1.2) for the first word may be the same as the proportion of the first word. For example, as illustrated in FIG. 5, the proportion of a second word (e.g., PAGES) of the sample document 500 may be a value (e.g., 0.5) obtained by dividing the area (e.g., 2.5) of a second detection box 520 including the second word by the number of characters (e.g., 5) of the second word. Since only one second detection box 520 is detected, the visual weight (e.g., 0.5) for the second word may be the same as the proportion of the first word. As another example, as illustrated in FIG. 5, the proportion of a third word (e.g., School) of the sample document 500 may be a value (e.g., 0.8) obtained by dividing the area (e.g., 4.8) of a third detection box 530 including the third word by the number of characters (e.g., 6) of the third word. Since three third detection boxes 531, 532, and 533 are detected in the document, the visual weight (e.g., 2.4=0.8*3) for the third word may be the same as the value obtained by multiplying the proportion of the third word by 3. As such, the electronic device may calculate visual weights for all words included in the document. The calculated visual weight may be used to calculate the keyword weight. As such, the electronic device may set words (e.g., titles) that are visually emphasized in documents with high visual weights as words having high importance in the corresponding document by calculating keyword weights using visual weights of words.

In operation 430, the electronic device may perform layout clustering. According to an embodiment, the electronic device may perform layout clustering on sample documents to classify the category of each sample document.

In operation 440, the electronic device may calculate a frequency weight. According to an embodiment, the electronic device may calculate a frequency weight per category for each word included in the sample documents. The frequency weight per category may be calculated using Equation 1 described above.

In operation 450, the electronic device may generate a dictionary. According to an embodiment, the electronic device may generate a keyword weight using the visual weight and frequency weight (e.g., frequency weight per category) for each word included in the sample document, and generate a dictionary based on the keyword weight. The dictionary generated in this way may include dictionary information each category of a plurality of categories. The dictionary information corresponding to each category may include at least one keyword for the corresponding category and a keyword weight associated with at least one keyword.

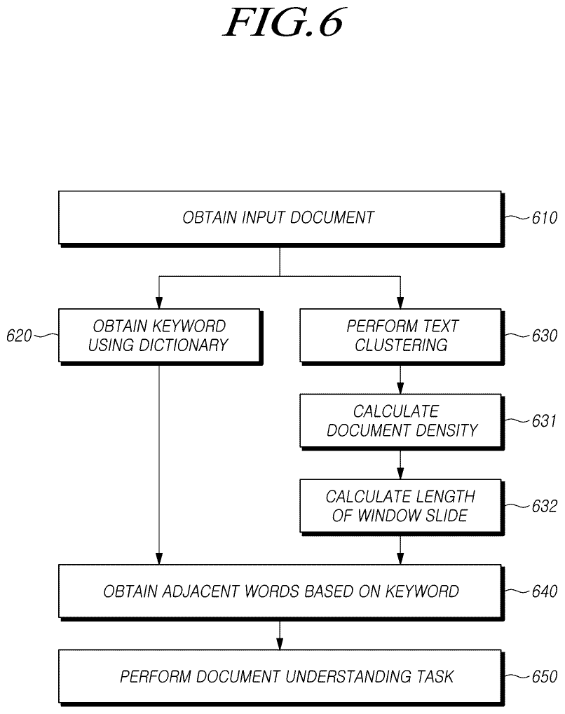

FIG. 6 is a flowchart illustrating a method for an electronic device to perform a designated task using a generated dictionary according to an embodiment of the disclosure.

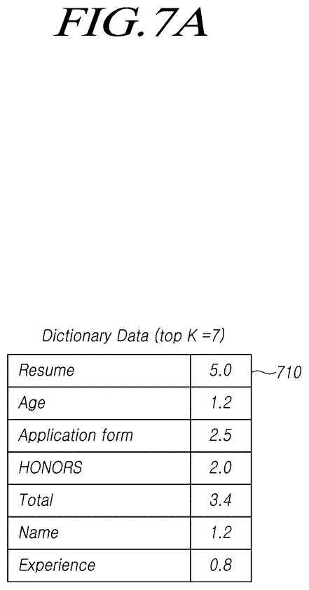

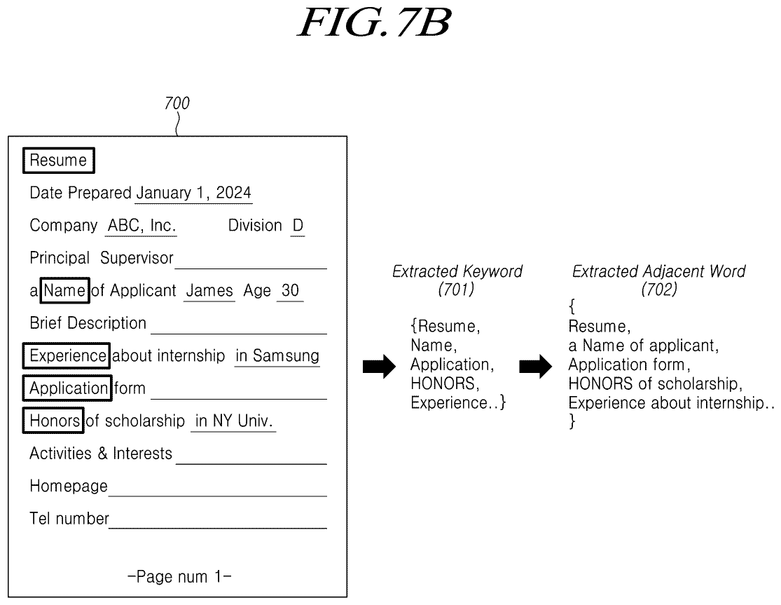

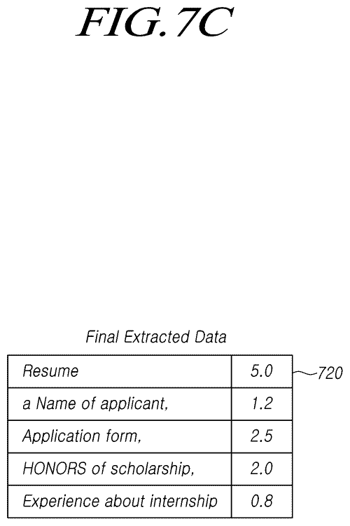

FIGS. 7A to 7C are views illustrating an operation of an electronic device extracting keywords and adjacent words from an input document using a generated dictionary according to an embodiment of the disclosure.

According to an embodiment, the method of performing a designated task using a generated dictionary may be performed by a keyword extraction module (e.g., the keyword extraction module 220 of FIG. 2), an adjacent word extraction module (e.g., the adjacent word extraction module 230 of FIG. 2), and/or a document understanding task execution module (e.g., the document understanding task execution module 240 of FIG. 2). Operations 610 to 650 of FIG. 6 may include all or some of the operations of the keyword extraction module 220, the adjacent word extraction module 230, and/or the document understanding task execution module 240 described above in FIG. 2.

Referring to FIG. 6, in operation 610, an electronic device (e.g., the electronic device 101 of FIG. 1 or FIG. 2) may obtain an input document. According to an embodiment, the electronic device may perform layout clustering on the input document to identify the category (e.g., resume) of the input document. According to an embodiment, in case that the input document is in image form, the electronic device may perform an optical character recognition (OCR) operation on the input document to recognize characters of the input document.

In operation 620, the electronic device may obtain (e.g., extract) at least one keyword from the input document using the dictionary. According to an embodiment, the electronic device may extract at least one keyword from the input document using dictionary information corresponding to the category of the input document. For example, as illustrated in FIG. 7A, in case that the K value, which is a parameter for Top K selection, is set to 7, dictionary information (dictionary data) corresponding to a specific category (e.g., resume) may be as shown in Table 1 (710). Referring to Table 1 (710), dictionary information corresponding to a specific category may include seven keywords selected through Top K selection and a keyword weight associated with each keyword. In Table 1 (710), the keywords are in the left column and the corresponding weights are in the right column. For example, Table 1 (710) may include a keyword such as “HONORS” and the weight 2.0 of the corresponding keyword. The electronic device may extract keywords 701 from the input document 700 based on dictionary information such as Table 1 (710). The keywords 701 extracted in this way may be {Resume, Name, Application, HONORS, Experience, . . . } as illustrated in FIG. 7B.

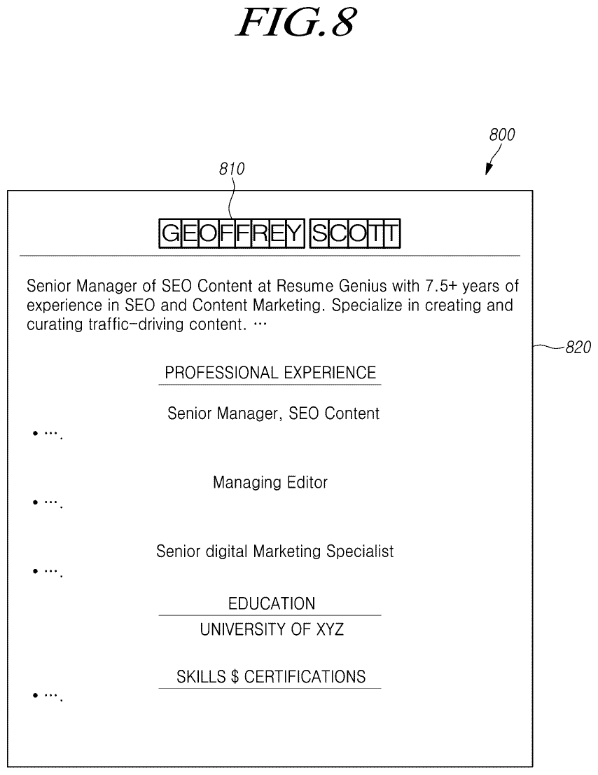

In operation 630, the electronic device may perform text clustering (e.g., character clustering) on the input document. In operation 631, the electronic device may calculate document density for the input document using the result of text clustering. In operation 632, the electronic device may calculate the length of a window slide for the input document based on document density information. Such operations 630 to 632 may be operations performed in advance to extract adjacent words adjacent to keywords. In some embodiments, operations 630 to 632 may be performed in parallel with or simultaneously with operation 620. An example of operations 630 to 632 is described below with reference to FIGS. 8 to 10.

In operation 640, the electronic device may obtain adjacent words based on keywords. According to an embodiment, the electronic device may obtain (e.g., extract) at least one adjacent word for each keyword based on the length of the window slide. The adjacent words 702 for each keyword 701 extracted in this way may be {Resume, a Name of applicant, Application form, HONORS of scholarship, Experience about internship, . . . } as illustrated in FIG. 7B. For example, adjacent words for the keyword “Name” may be “a”, “of”, “applicant”.

Data including keywords and adjacent words finally extracted through the above-described processes may be as shown in Table 2 (720) of FIG. 7C. Referring to Table 2 (720), the finally extracted data may include combinations of five extracted keywords and adjacent words and a keyword weight associated with each keyword. For example, Table 2 (720) may include a keyword and adjacent word combination such as “HONORS of scholarship” and the weight 2.0 of the corresponding keyword. Such extracted data may be used for the electronic device to perform a designated task.

In operation 650, the electronic device may perform a designated task (e.g., document understanding task). According to an embodiment, the electronic device may perform a designated task using a designated model (e.g., document classification model) based on the extracted data.

According to an embodiment of the disclosure, the electronic device may perform a document understanding task based on understanding of the document by performing a designated task using data extracted. The data extracted may be based on an understanding of the input document. Understanding of the input document may include, for example, visual-centric understanding of each word included in the input document and/or information-centric understanding of each word included in the input document. Visual-centric understanding may be based on, for example, visual weight. Information-centric understanding may be based on, for example, frequency weight (e.g., frequency weight per category). Since the data used to perform the designated task is data extracted based on document understanding, even in case that the corresponding data is abbreviated data of the text data of the document, it may be data including most of the important information of the document. Therefore, even in case that the electronic device performs a designated task using abbreviated data, it may obtain desired accurate results.

FIG. 8 is a view illustrating an operation of an electronic device obtaining document density and window slide length using character clustering according to an embodiment of the disclosure.

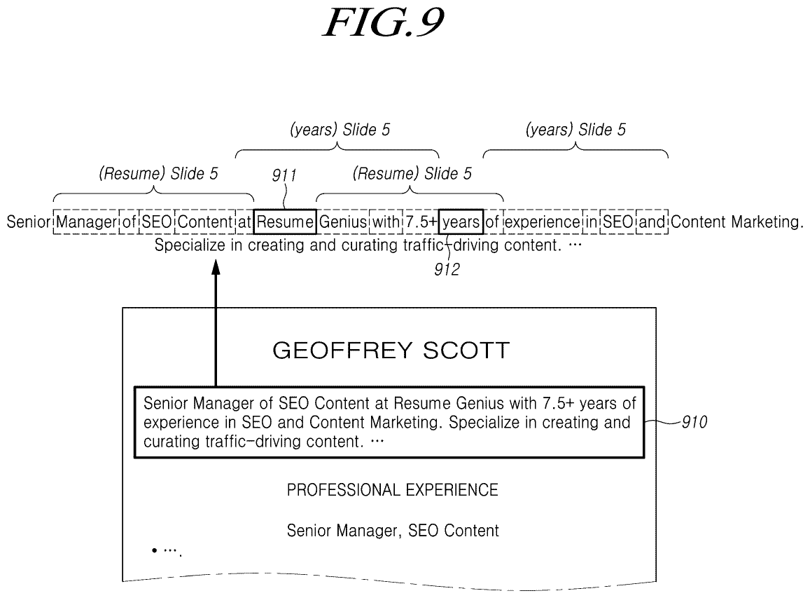

FIG. 9 is a view illustrating an operation of an electronic device obtaining adjacent words for keywords using window slide length according to an embodiment of the disclosure.

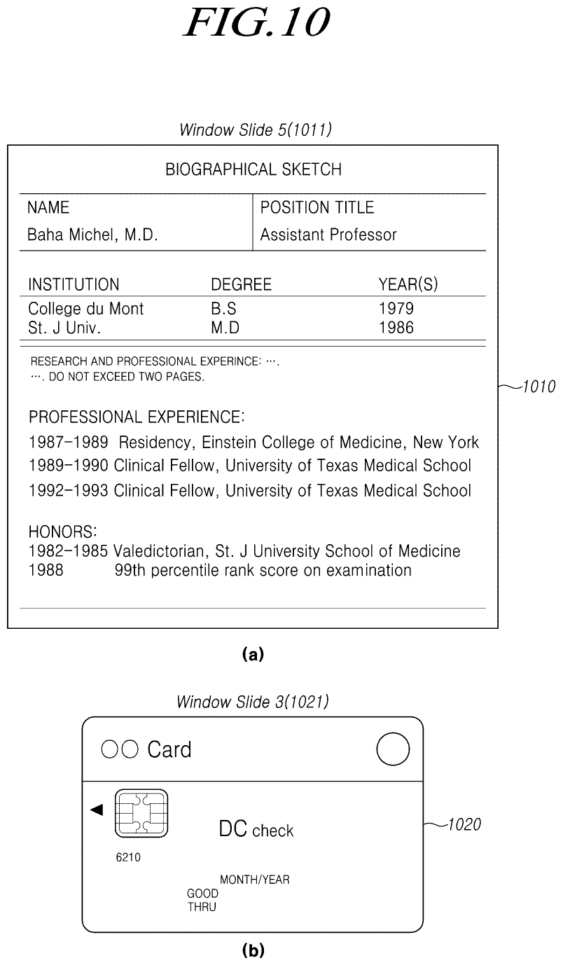

FIG. 10 is a view illustrating an example of window slide length set differently according to document density according to an embodiment of the disclosure.

In the embodiments illustrated in FIGS. 8 to 10, an example is described in which one window slide length is set for one input document. Meanwhile, according to the embodiment, different window slide lengths may be set for multiple portions of one input document. For example, the window slide length used to obtain adjacent words for a first keyword included in a first portion of an input document may be set to a first value based on the document density of the first portion, and the window slide used to obtain adjacent words for a second keyword included in a second portion of the input document different from the first portion may be set to a second value different from the first value based on the document density of the second portion.

Referring to FIG. 8, an electronic device (e.g., the electronic device 101 of FIG. 1 or FIG. 2) may obtain document density (or document density information) for an input document 800 based on the total number of characters included in the input document 800 and/or the total area of characters included in the input document 800. For example, the electronic device may calculate document density for the input document 800 using Equation 2 described above. To obtain such document density, the electronic device may perform at least one of the operations described below.

According to an embodiment, the electronic device may perform character clustering on the input document 800 to assign a detection box 810 to each character of the input document 800. For example, as illustrated in FIG. 8, separate detection boxes 810 may be allocated to each character “G”, “E”, “O”, “F”, “F”, “R”, “E”, “Y”, “S”, “C”, “O”, “T”, and “T” of the “GEOFFREY SCOTT” portion. Meanwhile, in FIG. 8, detection boxes 810 are illustrated as allocated only to the “GEOFFREY SCOTT” portion for convenience of description, but it may be understood that detection boxes 810 may be allocated to all characters included in the input document 800. In some embodiments, detection boxes 810 are allocated to all characters included in the input document 800, so that all characters may be detected. The shape of the detection box 810 may be rectangular as illustrated in FIG. 8, but the disclosure is not limited thereto.

According to an embodiment, the electronic device may obtain the total number of characters included in the input document 800 based on the number of detection boxes 810. For example, the electronic device may identify the total number of detection boxes 810 allocated to the input document 800 and set the corresponding total number as the total number of characters included in the input document 800.

According to an embodiment, the electronic device may obtain the total area of characters included in the input document 800 based on the area (or size) of the detection boxes 810. For example, the electronic device may identify a minimum rectangle 820 including all detection boxes 810 allocated to the input document 800 and set the area of the corresponding minimum rectangle 820 as the total area of characters included in the input document 800.

Referring to FIG. 9, the electronic device may obtain (e.g., extract) at least one adjacent word for each keyword based on the length of a window slide set based on document density (or document density information) for the input document 800. In the example of FIG. 9, for convenience of description, it is assumed that a “Resume” keyword 911 and a “years” keyword 912 are extracted from a specific portion 910 of the input document 800, and the length of the window slide is set to 5. However, the embodiment is not limited thereto, and the number and types of extracted keywords and the window slide length may vary.

According to an embodiment, the electronic device may extract five words (e.g., Manager, of, SEO, Content, at) positioned before the “Resume” keyword 911 and five words (e.g., Genius, with, 7.5+, years, of) positioned after the “Resume” keyword 911 based on the window slide length (e.g., 5). The electronic device may select all or some of the extracted words as adjacent words of the “Resume” keyword 911.

According to an embodiment, the electronic device may extract five words (e.g., at, Resume, Genius, with, 7.5+) positioned before the “years” keyword 912 and five words (e.g., of, experience, in SEO, and) positioned after the “years” keyword 912 based on the window slide length (e.g., 5). The electronic device may select all or some of the extracted words as adjacent words of the “years” keyword 912.

Referring to FIG. 10, the electronic device may set the length of the window slide for an input document differently according to the document density (or document density information) of the input document. For example, the electronic device may set the length of the window slide for an input document longer as the document density of the input document increases. As an example, in case that the input document is a first document 1010 (e.g., a sentence-type document (e.g., BIOGRAPHICAL SKETCH document)) having relatively higher document density compared to a second document 1020 (e.g., a word-type document (e.g., card document)), the electronic device may set the window slide length 1011 (e.g., 5) for the first document 1010 longer than the window slide length 1021 (e.g., 3) for the second document 1020. As such, by adaptively setting the length of the window slide used to extract adjacent words considering the document density of the input document, the accuracy of adjacent word extraction may be increased.

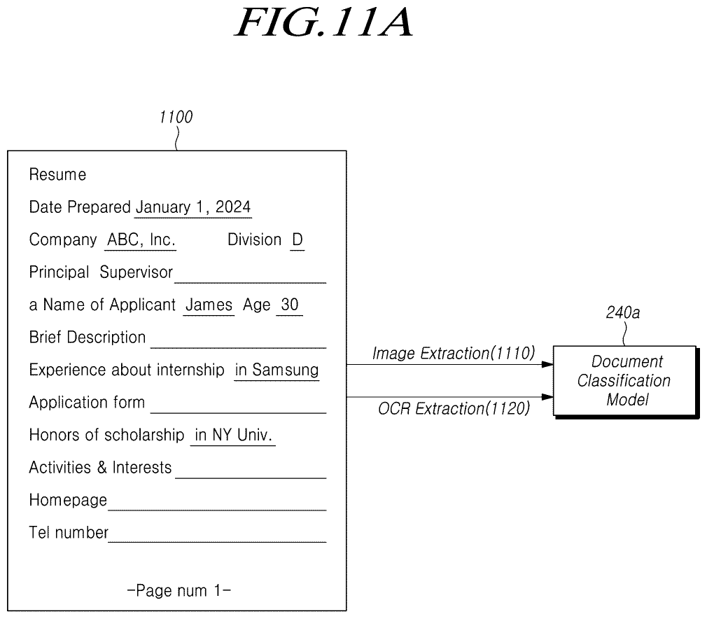

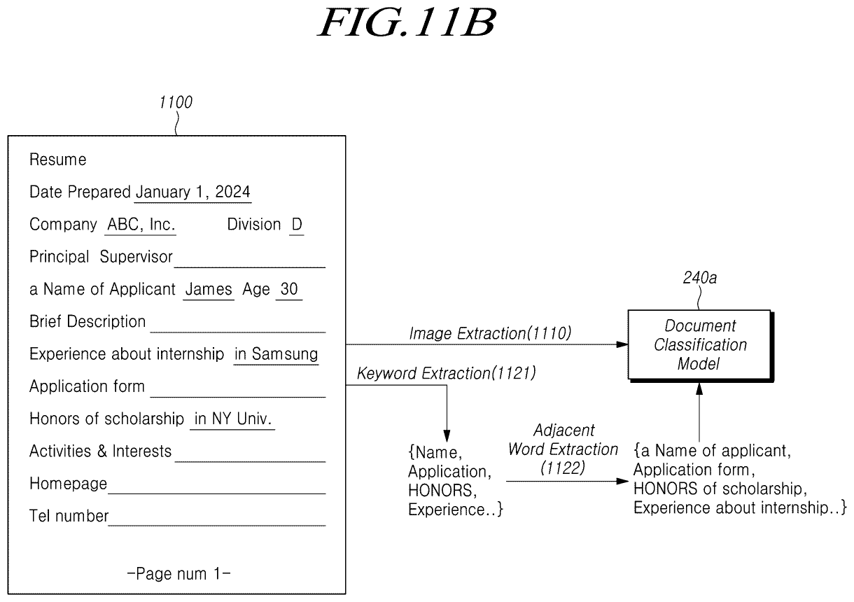

FIG. 11A is a view illustrating an operation of an electronic device performing a document classification task using a first method according to an embodiment of the disclosure.

FIG. 11B is a view illustrating an operation of an electronic device performing a document classification task using a second method according to an embodiment of the disclosure.

In the embodiments of FIGS. 11A and 11B, the first method of FIG. 11A corresponds to a method using entire text data extracted from an input document as input data of the document classification model 240a, and the second method of FIG. 11B corresponds to the proposed method of the disclosure using keywords and adjacent words extracted from an input document as input data of the document classification model 240a. The operation according to the second method may include all or some of the operations described above in FIGS. 2 to 10.

In the embodiments of FIGS. 11A and 11B, for convenience of description, the input document 1100 is described as an example being a document corresponding to a resume (or resume image) (e.g., the input document 700 of FIG. 7B), but the disclosure is not limited thereto. For example, documents of various categories may be used as the input document 1100.

According to an embodiment, the document classification model 240a may be included in a document understanding task execution module (e.g., the document understanding task execution module 240 of FIG. 2). In some embodiments, the document classification model 240a may be implemented as a small-sized on-device model (e.g., small language model (sLM)) that does not include OCR functionality. The document classification model 240a, which may be an on-device model, may be stored in a memory (e.g., the memory 130 of FIG. 1 or FIG. 2) of an electronic device (e.g., the electronic device 101 of FIG. 1 or FIG. 2).

Referring to FIG. 11A, the electronic device may input image data obtained through image extraction 1110 on the input document 1100 and text data (OCR data) obtained through OCR extraction 1120 on the input document 1100 as input data to the document classification model 240a. The document classification model 240a may classify the input document 1100 as a resume based on the input data.

Referring to FIG. 11B, the electronic device may input image data obtained through image extraction 1110 on the input document 1100, keyword data obtained through keyword extraction 1121 on the input document 1100 (e.g., keyword extraction using the keyword extraction module 220 of FIG. 2), and adjacent word data obtained through adjacent word extraction 1122 on the input document 1100 (e.g., keyword extraction using the adjacent word extraction module 230 of FIG. 2) as input data to the document classification model 240a. The document classification model 240a may classify the input document 1100 as a resume based on the input data.

Compared to the embodiment of FIG. 11A using the OCR data itself of the input document 1100 as input data, in the embodiment of FIG. 11B, using only data including keywords and adjacent words among the text data of the input document 1100 as input data, the size of input data input to the document classification model 240a may be decreased (e.g., about 8% size reduction).

Meanwhile, in case that the document classification model 240a is implemented as a small-sized on-device model that does not include OCR functionality, compared to the embodiment of FIG. 11A inputting OCR data obtained through OCR extraction 1120 on the input document 1100 as is, in the embodiment of FIG. 11B, by inputting keywords including information with high importance in the corresponding input document 1100 obtained through keyword extraction 1121 on the input document 1100, the classification performance of the document classification model 240 a may be enhanced (e.g., about 5% performance improvement). Further, compared to the embodiment of FIG. 11A inputting data obtained through OCR extraction 1110 on the input document 1100 as is or an embodiment inputting only keywords obtained through keyword extraction 1121 on the input document 1100, in the embodiment of FIG. 11B, by inputting not only keywords obtained through keyword extraction 1121 on the input document 1100 but also adjacent words that make the contextual meaning of keywords clearer obtained through adjacent word extraction 1122, the classification performance of the document classification model 240a may be enhanced (e.g., about 8% performance improvement).

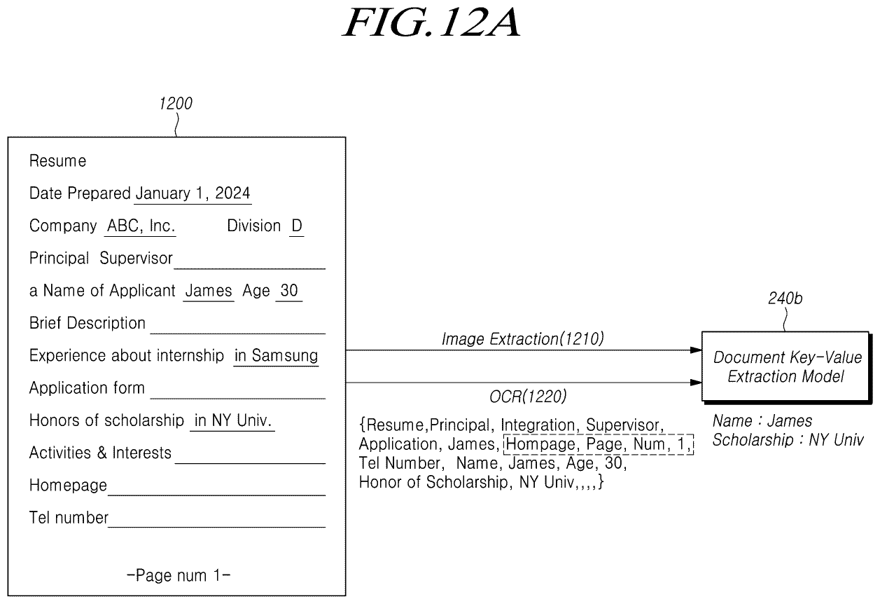

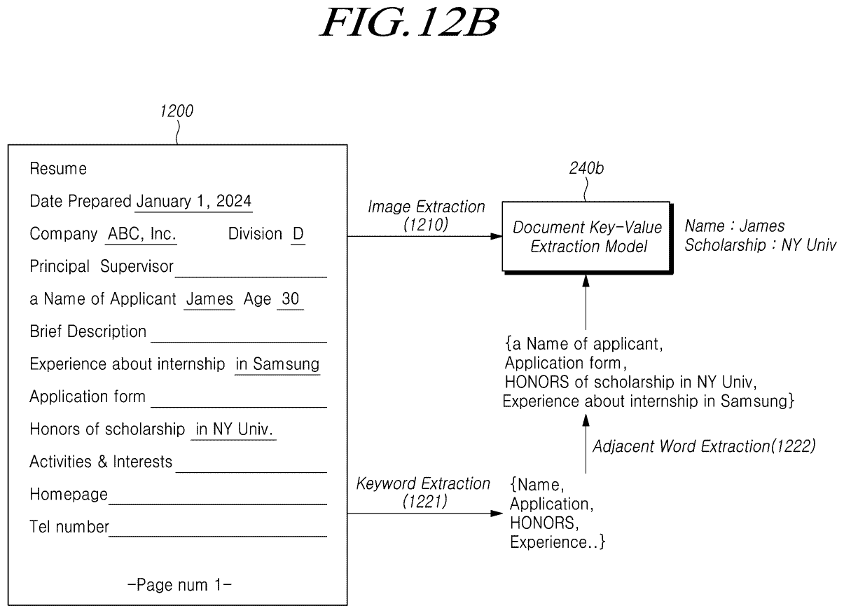

FIG. 12A is a view illustrating an operation of an electronic device performing a document key-value extraction task using a first method according to an embodiment of the disclosure.

FIG. 12B is a view illustrating an operation of an electronic device performing a document key-value extraction task using a second method according to an embodiment of the disclosure.

In the embodiments of FIGS. 12A and 12B, the first method in FIG. 12A corresponds to a method using entire text data extracted from an input document as input data of the document key-value extraction model 240b, and the second method in FIG. 12B corresponds to the proposed method of the disclosure using keywords and adjacent words extracted from an input document as input data of the document key-value extraction model 240b. The operation according to the second method may include all or some of the operations described above in FIGS. 2 to 10.

In the embodiments of FIGS. 12A and 12B, for convenience of description, the input document 1200 is described as an example being a document corresponding to a resume (or resume image) (e.g., the input document 700 of FIG. 7B), but the disclosure is not limited thereto. For example, documents of various categories may be used as the input document 1200.

According to an embodiment, the document key-value extraction model 240b may be included in a document understanding task execution module (e.g., the document understanding task execution module 240 of FIG. 2). In some embodiment, the document key-value extraction model 240b may be implemented as a small-sized on-device model (e.g., sLM) that does not include OCR functionality. The document key-value extraction model 240b, which is an on-device model, may be stored in a memory (e.g., the memory 130 of FIG. 1 or FIG. 2) of an electronic device (e.g., the electronic device 101 of FIG. 1 or FIG. 2). The key-value extracted through the document key-value extraction model 240b may be, for example, a value providing key information in the corresponding document.

Referring to FIG. 12A, the electronic device may input image data obtained through image extraction 1210 on the input document 1200 and text data (OCR data) obtained through OCR extraction 1220 on the input document 1200 as input data to the document key-value extraction model 240b. The document key-value extraction model 240b may extract Name (e.g., James) and Scholarship (e.g., NY Univ) values as key-values from the input document 1200 based on the input data.

Referring to FIG. 12B, the electronic device may input image data obtained through image extraction 1210 on the input document 1200, keyword data obtained through keyword extraction 1221 on the input document 1200 (e.g., keyword extraction using the keyword extraction module 220 of FIG. 2), and adjacent word data obtained through adjacent word extraction 1222 on the input document 1200 (e.g., keyword extraction using the adjacent word extraction module 230 of FIG. 2) as input data to the document key-value extraction model 240b. The document key-value extraction model 240b may extract Name (e.g., James) and Scholarship (e.g., NY Univ) values as key-values from the input document 1200 based on the input data.

In the embodiment of FIG. 12A using OCR data itself extracted through OCR extraction 1220 on the input document 1200 as input data, information unnecessary for key-value extraction (e.g., words such as Homepage, Page, Num, 1 included in the dotted box of FIG. 12A) may be input to the document key-value extraction model 240b. In contrast, in the embodiment of FIG. 12B, using data including keywords and adjacent words among the text data of the input document 1200 as input data, data unnecessary for key-value extraction is not input to the document classification model 240a, and the size of input data may be decreased (e.g., about 8% size reduction).

Meanwhile, in case that the document key-value extraction model 240b is implemented as a small-sized on-device model that does not include OCR functionality, compared to the embodiment of FIG. 12A inputting data obtained through OCR extraction 1220 on the input document 1200 as is, in the embodiment of FIG. 12B, by inputting keywords including information with high importance in the corresponding input document 1200 obtained through keyword extraction 1221 on the input document 1200, the key-value extraction performance of the document key-value extraction model 240b may be enhanced (e.g., about 5% performance increase). Further, compared to the embodiment of FIG. 12A inputting data obtained through OCR extraction 1220 on the input document 1200 as is or an embodiment inputting only keywords obtained through keyword extraction 1221 on the input document 1200, in the embodiment of FIG. 12B, by inputting not only keywords obtained through keyword extraction 1221 on the input document 1200 but also adjacent words that make the contextual meaning of keywords clearer obtained through adjacent word extraction 1222, the key-value extraction performance of the document key-value extraction model 240b may be enhanced (e.g., about 8% performance increase).

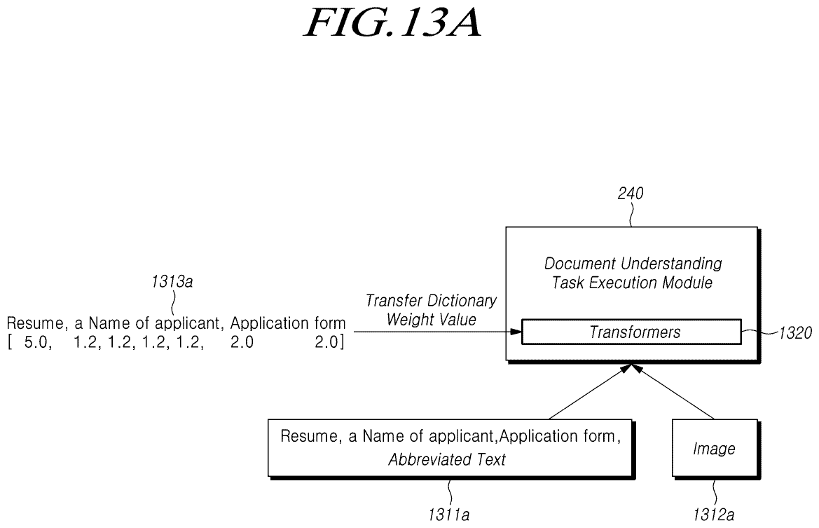

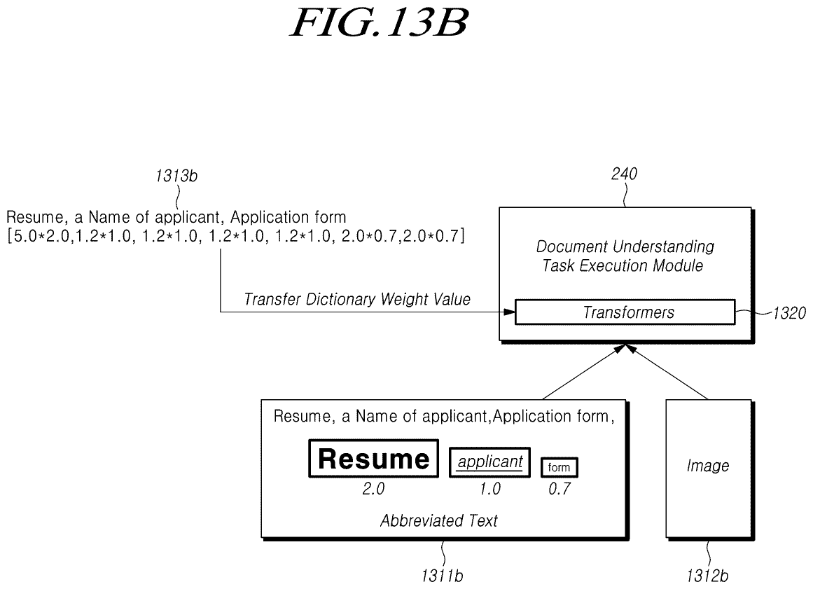

FIGS. 13A and 13B are views illustrating an operation of an electronic device performing a designated task using weights together with keywords and adjacent words according to an embodiment of the disclosure.

In the embodiments of FIGS. 13A and 13B, an input document may be a document corresponding to a resume (or resume image) (e.g., the input document 700 of FIG. 7B), but the disclosure is not limited thereto. For example, documents of various categories may be used as input documents.

According to an embodiment, an electronic device (e.g., the electronic device 101 of FIG. 1 or FIG. 2) may input first data 1311a, 1311b obtained through keyword extraction and adjacent word extraction on an input document and second data 1312a, 1312b obtained through image extraction on the input document as input data to the document understanding task execution module 240. Keyword extraction may be performed using a keyword extraction module (e.g., the keyword extraction module 220 of FIG. 2). Adjacent word extraction may be performed using an adjacent word extraction module (e.g., adjacent word extraction using the adjacent word extraction module 230 of FIG. 2). The first data 1311a, 1311b may be abbreviated text data compared to OCR data (OCR text) obtained through OCR extraction. As illustrated in FIGS. 13A and 13B, the first data 1311a, 1311b may include extracted keywords and adjacent words {Resume, a Name of applicant, Application form, . . . }.

According to an embodiment, the electronic device may input third data 1313a, 1313b including weight data together with the first data 1311a, 1311b and the second data 1312a, 1312b to the document understanding task execution module 240.

According to an embodiment, the third data 1313a, 1313b may include information about dictionary weights (e.g., keyword weights) and/or information about visual weights of the input document. For example, as illustrated in FIG. 13A, the third data 1313a may include dictionary weight values (e.g., Resume (5.0), a (1.2), Name (1.2), of (1.2), applicant (1.2), Application (2.0), form (2.0)) corresponding to each word included in the first data 1311a. For example, as illustrated in FIG. 13B, the third data 1313b may include values obtained by multiplying keyword weight values stored in the dictionary of each word included in the first data 1311b by visual weight values of the corresponding word (e.g., Resume (5.0*2.0), a (1.2*1.0), Name (1.2*1.0), of (1.2*1.0), applicant (1.2*1.0), Application (2.0*0.7), form (2.0*0.7)). The visual weight value of each word may be obtained through analysis of the input document.

According to an embodiment, the third data 1313a, 1313b may be transferred to an attention-based model 1320 included in the document understanding task execution module 240. According to an embodiment, the attention-based model 1320 may be a transformer model or a cross-attention model. The third data 1313a, 1313b transferred to the attention-based model 1320 in this way may be used together with the first data 1311a, 1311b and the second data 1312a, 1312b to perform inference through the corresponding model. By further using keyword weights and/or visual weights as input data, the inference accuracy of the model may be enhanced.

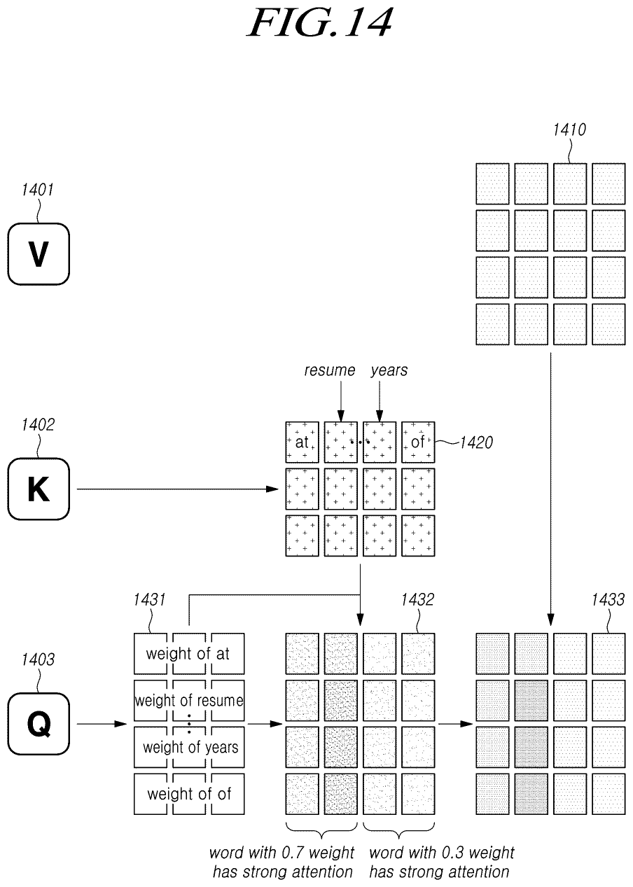

FIG. 14 is a view illustrating an operation of an electronic device performing a designated task through an attention-based model using weights according to an embodiment of the disclosure. In the embodiment of FIG. 14, for convenience of description, an example is described in which text data including extracted keywords and adjacent words includes {at, Resume, Genius, with, 7.5+, years, of, . . . } and keyword weight values corresponding to each word included in the text data are {at (0.7), Resume (0.7), Genius (0.7), with (0.7), 7.5+ (0.7 ), years (0.3), of (0.3), . . . }.

According to an embodiment, an electronic device (e.g., the electronic device 101 of FIG. 1 or FIG. 2) may transfer text data including keywords and adjacent words (e.g., the first data 1311a, 1311b of FIGS. 13A and 13B) and weight data including information about weights (e.g., the third data 1313a, 1313b of FIGS. 13A and 13B) to an attention-based model (e.g., the attention-based model 1320 of FIGS. 13A and 13B) of a document understanding task execution module (e.g., the document understanding task execution module 240 of FIG. 2). According to an embodiment, the attention-based model 1320 may be a transformer model or a cross-attention model.

According to an embodiment, cross-attention may be used to calculate the association between two data. For example, cross-attention may extract important information from Key (K) 1402 and Value (V) 1401 based on Query (Q) 1403. As illustrated in FIG. 14, Q 1403 may represent weight data 1431 including the weight of each word included in text data, and K 1402 and V 1401 may represent embedding data (e.g., embedding vectors) 1410, 1420 of text data. For example, the electronic device may obtain an embedding vector of each word included in text data and generate Q 1403 by multiplying the obtained embedding vector by weight data. The electronic device may convert the embedding vector of each word included in text data to K 1402 and V 1401. K 1402 may serve as a reference for calculating similarity with Q 1403, and V 1401 may include information to be returned according to Q 1403.

According to an embodiment, the electronic device may calculate an attention score 1432 based on data 1431 of Q 1403 and data 1420 of K 1402. For example, the electronic device may calculate an attention score through inner product between data 1431 of Q 1403 and data 1420 of K 1402 to obtain attention score data 1432. The attention score data 1432 indicates that for predetermined vectors, words with 0.7 weight have strong attention (high attention score), and for other predetermined vectors, words with 0.3 weight have strong attention (high attention score). The electronic device may generate final data 1433 by applying a weighted sum to data 1410 of V 1401 using the attention score data 1432. Through this operation considering weights, the inference performance of the document understanding task execution module may be enhanced.

Various embodiments as set forth herein may be implemented as software (e.g., the program 140) including one or more instructions that are stored in a storage medium (e.g., the internal memory 136 of FIG. 1 or external memory 138 of FIG. 1) that is readable by a machine (e.g., the electronic device 101 of FIG. 1). For example, a processor (e.g., the processor 120 of FIG. 1) of the machine (e.g., the electronic device 101 of FIG. 1) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
at least one processor comprising processing circuitry; and
memory configured to store instructions, wherein the instructions, when executed individually or collectively by the at least one processor, cause the electronic device to:
obtain at least one keyword from an input document using dictionary information, wherein
the dictionary information corresponds to a category of the input document, and
the dictionary information comprises 1) a plurality of keywords associated with the category and 2) a keyword weight associated with each keyword of the plurality of keywords;
obtain at least one adjacent word for the at least one keyword from the input document using a window slide, wherein the window slide has a length set based on document density information of the input document; and
perform a designated task for the input document using the at least one keyword and the at least one adjacent word.

2. The electronic device of claim 1, wherein the document density information comprises a value obtained by dividing a total number of characters included in the input document by a total area of the characters included in the input document.

3. The electronic device of claim 2, wherein the instructions, when executed individually or collectively by the at least one processor, cause the electronic device to:
obtain the document density information using character clustering configured to detect each character included in the input document using a detection box.

4. The electronic device of claim 1, wherein the instructions, when executed individually or collectively by the at least one processor, cause the electronic device to:
generate a dictionary comprising the dictionary information based on 1) visual information for each word included in a plurality of sample documents and 2) frequency information for each word included in the plurality of sample documents.

5. The electronic device of claim 4, wherein generating the dictionary comprises:
obtaining the plurality of sample documents;
calculating a visual weight for each word included in the plurality of sample documents;
performing layout clustering on the plurality of sample documents to classify a category of each sample document in the plurality of sample documents;
calculating a frequency weight per category for each word included in the plurality of sample documents; and
generating the dictionary based on the visual weight and the frequency weight.

6. The electronic device of claim 5, wherein
the dictionary comprises dictionary information corresponding to each category of a plurality of categories,
the dictionary information corresponding to each category of the plurality of categories comprises 1) a plurality of keywords associated with a corresponding category and 2) a keyword weight associated with each of the plurality of keywords associated with the corresponding category, and
the keyword weight is set as a product of a visual weight and the frequency weight for a corresponding keyword.

7. The electronic device of claim 5, wherein the visual weight is set based on a value obtained by dividing an area occupied by a word in a corresponding sample document by a number of characters included in the word, and
wherein the frequency weight per category is set based on a value obtained by dividing a ratio of where a word is detected in at least one sample document of a corresponding category by a ratio of where the word is detected in sample documents of categories other than the corresponding category.

8. The electronic device of claim 1, wherein to obtain the at least one keyword comprises extracting K keywords having highest keyword weight values among a plurality of keywords included in the input document matching the plurality of keywords included in the dictionary information, and
wherein a value of K is set based on at least one of a size of a model used to perform the designated task, a size of input data of the model, or a memory environment of the electronic device.

9. The electronic device of claim 1, wherein the category of the document comprises at least one of a resume, a name card, a credit card, an identification card, an e-mail, or a form.

10. The electronic device of claim 1, wherein the designated task is performed based on a task execution module, and wherein the task execution module comprises at least one of a document classification model, a document key-value extraction model, or a document-based generative data generation model.

11. The electronic device of claim 10, wherein
the task execution module comprises an attention mechanism-based model,
the attention mechanism-based model is configured to receive, as input data, information about weight together with the at least one keyword and the at least one adjacent word, and to perform the designated task for the input document, and
the information about weight comprises information about a keyword weight of the at least one keyword included in the dictionary information or information about a weight obtained by multiplying the keyword weight of the at least one keyword included in the dictionary information by a visual weight of the at least one keyword.

12. A method of an electronic device, the method comprising:
obtaining at least one keyword from an input document using dictionary information, wherein
the dictionary information corresponds to a category of the input document, and
the dictionary information comprises 1) a plurality of keywords associated with the category and 2) a keyword weight associated with each keyword of the plurality of keywords;
obtaining at least one adjacent word for the at least one keyword from the input document using a window slide, wherein the window slide has a length set based on document density information of the input document; and
performing a designated task for the input document using the at least one keyword and the at least one adjacent word.

13. The method of claim 12, wherein the document density information comprises a value obtained by dividing a total number of characters included in the input document by a total area of the characters included in the input document.

14. The method of claim 13, further comprising:
obtaining the document density information using character clustering configured to detect each character included in the input document using a detection box.

15. The method of claim 12, further comprising generating a dictionary comprising the dictionary information based on 1) visual information for each word included in a plurality of sample documents and 2) frequency information for each word included in a plurality of sample documents.

16. The method of claim 15, wherein generating the dictionary comprises:
obtaining the plurality of sample documents;
calculating a visual weight for each word included in the plurality of sample documents;
performing layout clustering on the plurality of sample documents to classify a category of each sample document in a plurality of sample documents ;
calculating a frequency weight per category for each word included in the plurality of sample documents; and
generating the dictionary based on the visual weight and the frequency weight.

17. The method of claim 16, wherein
the dictionary comprises dictionary information corresponding to each category of a plurality of categories,
the dictionary information corresponding to each category of the plurality of categories comprises 1) a plurality of keywords associated with a corresponding category and 2) a keyword weight associated with each of the plurality of keywords associated with the corresponding category, and
the keyword weight is set as a product of a visual weight and the frequency weight for a corresponding keyword.

18. The method of claim 16, wherein the visual weight is set based on a value obtained by dividing an area occupied by a word in a corresponding sample document by a number of characters included in the word, and wherein the frequency weight per category is set based on a value obtained by dividing a ratio of where a word is detected in at least one sample document of a corresponding category by a ratio of where the word is detected in sample documents of categories other than the corresponding category.

19. The method of claim 12, wherein obtaining the at least one keyword comprises extracting K keywords having highest keyword weight values among a plurality of keywords included in the input document matching the plurality of keywords included in the dictionary information, and
wherein a value of K is set based on at least one of a size of a model used to perform the designated task, a size of input data of the model, or a memory environment of the electronic device.

20. The method of claim 12, wherein
the designated task is performed based on a task execution module, and wherein the task execution module comprises an attention mechanism-based model,
the attention mechanism-based model is configured to receive, as input data, information about weight together with the at least one keyword and the at least one adjacent word, and to perform the designated task for the input document, and
the information about weight comprises information about a keyword weight of the at least one keyword included in the dictionary information or information about a weight obtained by multiplying the keyword weight of the at least one keyword included in the dictionary information by a visual weight of the at least one keyword.
